(19) United States
(12) Patent Application Publication
(10) Pub. No.: US 2017/0360263 A1
(43) Pub. Date: Dec. 21, 2017

(54) BUTTOCK WIPING ARM AND BUTTOCK WIPING DEVICE USING THE SAME

(71) Applicant: OKADA MANUF. CO., LTD., Osaka (JP)

(72) Inventor: Shoji OKADA, Osaka (JP)

(21) Appl. No.: 15/626,515

(22) Filed: Jun. 19, 2017

(30) Foreign Application Priority Data
Jun. 21, 2016 (JP) 2016-122830
Apr. 24, 2017 (JP) 2017-085476

(51) Int. Cl. A47K 7/08; G01L 5/00; G01L 1/22; G05D 15/01; A47K 7/04

(52) U.S. Cl. CPC A47K 7/08; G05D 15/01; A47K 7/04; G01L 1/2206; G01L 5/0038

(57) ABSTRACT

The present disclosure is intended to provide a buttock wiping device configured so that pressure on the buttocks in wiping can be adjusted and a buttock wiping arm used for the buttock wiping device. The present disclosure relates to a wiping arm whose operation is controlled by a buttock wiping device for wiping the buttocks with a wiping material. The wiping arm includes an arm portion, a head portion configured to press the wiping material against the buttocks, and a force sensor configured to detect force when the wiping material is pressed against the buttocks. The force sensor is a strain gauge, a load cell, or a semiconductor pressure sensor.

### CROSS-REFERENCE TO RELATED APPLICATION

This application claims priority from Japanese Patent Application Nos. 2016-122830 filed on Jun. 21, 2016, and 2017-085476 filed on Apr. 24, 2017, with the Japan Patent Office, the entire contents of which are hereby incorporated by reference.

### BACKGROUND

### 1. Technical Field

The present disclosure relates to a buttock wiping arm used for a buttock wiping device for wiping the buttocks, and more specifically, relates to a buttock wiping arm configured so that the buttocks can be wiped with proper pressure.

### 2. Description of the Related Art

Typically, devices described in JP-A-2009-061126, JP-A-2009-263859, JP-A-2011-062532, JP-A-2011-143233, JP-A-2011-144623, JP-A-2011-200627, JP-A-2012-172486, JP-A-2014-064885, JP-A-2014-094261, JP-A-2014-113508, JP-A-2014-131775, JP-A-2014-132155, JP-A-2014-207949, JP-A-2014-233309, JP-A-2015-006603, JP-A-2015-062712, JP-A-2015-062825, JP-A-2015-104617, JP-A-2015-192893, JP-A-2016-028750, JP-A-2016-028751, JP-A-2016-034565, JP-A-2016-040013, JP-A-2016-041894, Chinese Utility Model Publication No. 2682113, Chinese Patent Application Publication No. 101368403, WO 2005/087067 A, German Patent No. 251031, WO 2016/152881 A, JP-A-2016-104222, JP-A-2016-179002, JP-A-2016-179003, JP-A-2016-214924, JP-A-2016-202588, JP-A-2016-221116, JP-A-2017-006619, JP-A-2017-006622, JP-A-2017-008679, JP-A-2017-008701, JP-A-2017-006616, and JP-A-2017-006617 have been known as a device for mechanically wiping, e.g., moisture or dirt on the buttocks. Each device described in JP-A-2009-061126, JP-A-2009-263859, JP-A-2011-062532, JP-A-2011-143233, JP-A-2011-144623, JP-A-2011-200627, JP-A-2012-172486, JP-A-2014-064885, JP-A-2014-094261, JP-A-2014-113508, JP-A-2014-131775, JP-A-2014-132155, JP-A-2014-207949, JP-A-2014-233309, JP-A-2015-006603, JP-A-2015-062712, JP-A-2015-062825, JP-A-2015-104617, JP-A-2015-192893, JP-A-2016-028750, JP-A-2016-028751, JP-A-2016-034565, JP-A-2016-040013, and JP-A-2016-041894 includes a wiping arm for attachment of toilet paper, and a wiping arm drive unit configured to drive the wiping arm. These devices are each configured so that the moisture etc. on the buttocks can be wiped in a state in which a head portion of the wiping arm to which the toilet paper is attached is pressed against the buttocks. Each buttock wiping device as described in WO 2016/152881 A, JP-A-2017-006616, and JP-A-2017-006617 is the following device configured so that the moisture etc. on the buttocks can be wiped: the buttock wiping device uses a paper placement guide driven separately from the wiping arm to move the wiping material such as toilet paper to below the buttocks, and then, the head portion of the wiping arm is moved upward from below the wiping material to press the wiping material against the buttocks.

Typically, JP-A-2011-200627 describes, in paragraph 0570, that the pressure of the wiping arm for pressing the buttocks may be changed according to a user's instruction. Moreover, JP-A-2012-172486 describes, in paragraph 0069, that a switch configured to select wiping pressure according to preferences may be provided.

Moreover, WO 2016/152881 A, JP-A-2017-006616, and JP-A-2017-006617 each describe that a pressure sensor may be provided at the head portion (a pressing portion) to measure the pressure on the buttocks and control a motor. However, WO 2016/152881 A, JP-A-2017-006616, and JP-A-2017-006617 have not been published at the priority date, and therefore, are not taken as the related art. Note that WO 2016/152881 A, JP-A-2017-006616, and JP-A-2017-006617 each describe that when the pressing portion contacts the buttocks with a pressure of equal to or higher than a certain value, such pressing is weakened by an upper-to-lower motor so that the pressing pressure can be adjusted. Moreover, WO 2016/152881 A, JP-A-2017-006616, and JP-A-2017-006617 each describe that for motor torque detection, a pressure sensor attached to the pressing portion may be used.

### SUMMARY

As described above, for the wiping arm used for the typical buttock wiping device, adjustment of the pressing pressure on the buttocks has been suggested, but specific mechanism, structure, principle, and function for adjustment of the pressing pressure on the buttocks have not been clearly described in detail.

Specifically, there is an individual difference in the degree of lowering of the buttocks. For example, in comparison between a person whose anus is greatly lowered from a toilet seat due to one's small pelvis and a person whose anus is positioned at the same height as that of the toilet seat, the allowable rising height of the wiping arm varies. In the latter case, the wiping arm needs to be moved up higher than in the former case. In the former case, when the wiping arm is moved up to the height of the latter case, the wiping arm pushes up the buttocks of the person of the former case more than necessary. When excessive force is applied to the buttocks by the wiping arm, there is a risk of damage on a private area such as the anus. Moreover, due to motor overload, there is a probability that the motor is damaged. For these reasons, for practical use of the buttock wiping device, it is an essential function to adjust the pressing pressure in wiping by the wiping arm.

Thus, the present disclosure is intended to provide a buttock wiping device configured so that pressure on the buttocks in wiping can be adjusted and a buttock wiping arm used for the buttock wiping device.

For solving the above-described problems, the present disclosure has the following features. The present disclosure relates to a buttock wiping arm whose operation is controlled by a buttock wiping device for wiping the buttocks with a wiping material. The buttock wiping arm includes an arm portion, a head portion configured to press the wiping material against the buttocks, and a force detection unit configured to detect force when the wiping material is pressed against the buttocks.

Preferably, the force detection unit may be a strain gauge, a load cell, or a semiconductor pressure sensor.

Preferably, the force detection unit may be attached such that the head portion applies the force to the force detection unit when the wiping material is pressed against the buttocks.

Preferably, the head portion may include an openable portion configured to hold the wiping material, and the force detection unit may be attached to the openable portion of the head portion.

Preferably, the force detection unit may be attached to the head portion.

Preferably, the force detection unit may be attached to the arm portion or the vicinity of the arm portion.

Preferably, the force detection unit may be a strain gauge attached to the arm portion, and the strain gauge may be configured to detect strain when the arm portion strains, thereby detecting the force.

Preferably, the force detection unit may be a load cell attached to a base portion of the arm portion, and the load cell may be configured to detect the force of pushing the load cell when the arm portion bends, thereby detecting the force.

The present disclosure relates to a buttock wiping device including the buttock wiping arm according to any one of the above-described aspects.

According to one embodiment of the present disclosure, the buttock wiping arm includes the force detection unit so that the force of pressing the head portion against the buttocks can be controlled. Thus, the buttock wiping device configured so that the pressure on the buttocks in wiping can be adjusted and the buttock wiping arm used for the buttock wiping device can be provided.

Since the strain gauge, the load cell, or the semiconductor pressure sensor is used as the force detection unit, the pressure can be detected with accuracy.

Since the head portion applies the pressure to the force detection unit, it is not necessary that the force detection unit directly contacts the buttocks. Thus, in cleansing of the head portion, it is not necessary to cleanse the force detection unit. Consequently, waterproofing of an electric system is facilitated.

With attachment of the force detection unit to the openable portion, the force can be also controlled at the openable head portion.

In the case of directly attaching the force detection unit to the head portion, the pressure can be also detected.

With attachment of the force detection unit to the arm portion or the vicinity thereof, it is not necessary to attach the force detection unit to the head portion. Thus, a maintenance process such as cleansing of the head portion is facilitated.

For example, attachment of the strain gauge to the arm portion or attachment of the load cell to the base portion not only allows force detection with a simple structure, but also facilitates the maintenance process such as cleansing of the head portion.

These objects, features, aspects, and advantageous effects of the present disclosure and other objects, features, aspects, and advantageous effects of the present disclosure will be, with reference to the attached drawings, further apparent from description made below.

### BRIEF DESCRIPTION OF THE DRAWINGS

FIG. 1A is a block diagram of a functional configuration of a buttock wiping device 1 using a paper placement guide 7;

FIG. 1B is a block diagram of a functional configuration of a buttock wiping device 1 when an openable portion 43 is used for a head portion 41;

FIG. 2A is a plan view of an outline mechanism of the buttock wiping device 1 illustrated in FIG. 1A;

FIG. 2B is a plan view of an outline mechanism of the buttock wiping device 1 illustrated in FIG. 1B;

FIG. 3 is a side view of a relationship among a toilet bowl 11, a toilet seat 12, a warm-water cleansing device 10, and a raised portion 13;

FIG. 4A is a plan view of a wiping am 4 of a first embodiment;

FIG. 4B is a front view of the wiping arm 4 of FIG. 4A;

FIG. 4C is a sectional view of the inside of a head portion 41 of FIG. 4B;

FIG. 5A is a perspective view of a wiping arm 4 of a second embodiment;

FIG. 5B is a perspective view of the wiping arm 4 with a head portion 41 of FIG. 5A being transparent for the sake of clarifying the inside of the head portion 41;

FIG. 6 is a sectional view of a head portion 41 of a wiping arm 4 of a third embodiment;

FIG. 7A is a block diagram of a functional configuration in a case where a force sensor 42 is attached to an arm portion 44 or the vicinity thereof;

FIG. 7B is a block diagram of a functional configuration in a case where a force sensor 42 is attached to an arm portion 44 or the vicinity thereof;

FIG. 8A is a side view when a strain gauge 45 as the force sensor 42 is attached to the arm portion 44;

FIG. 8B is a side view when a load cell 46 as the force sensor 42 is attached to the arm portion 44;

FIG. 9 is a side view of a wiping arm 4 in the case of providing a holding portion 50 at the arm portion 44; and

FIG. 10 is another side view of the wiping arm 4 in the case of providing the holding portion 50 at the arm portion 44.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

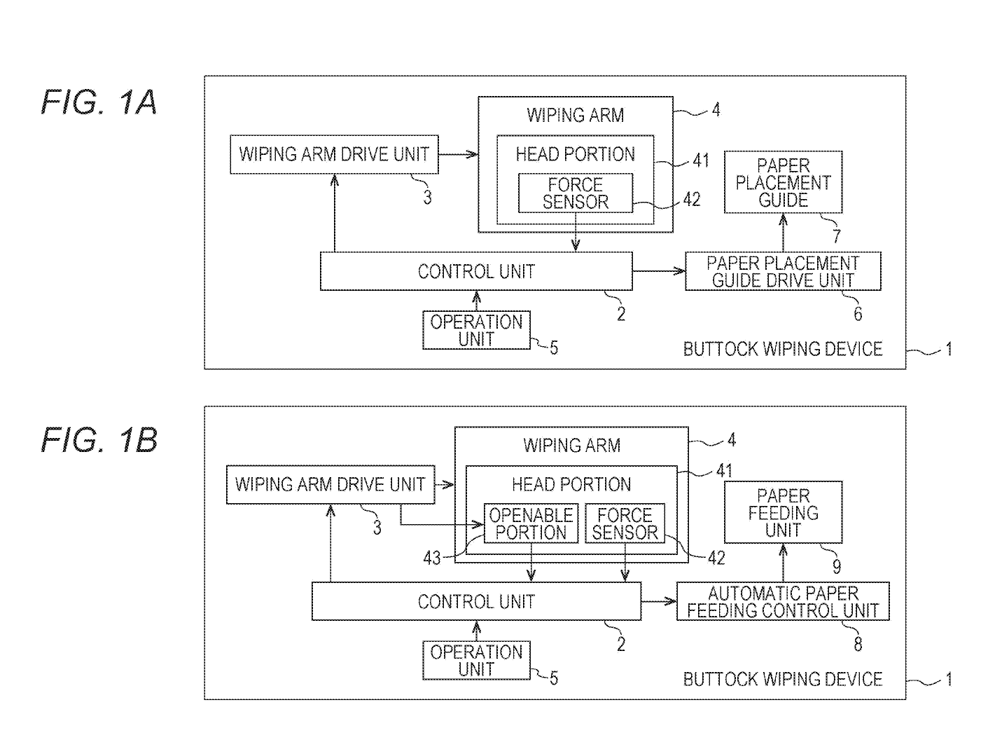

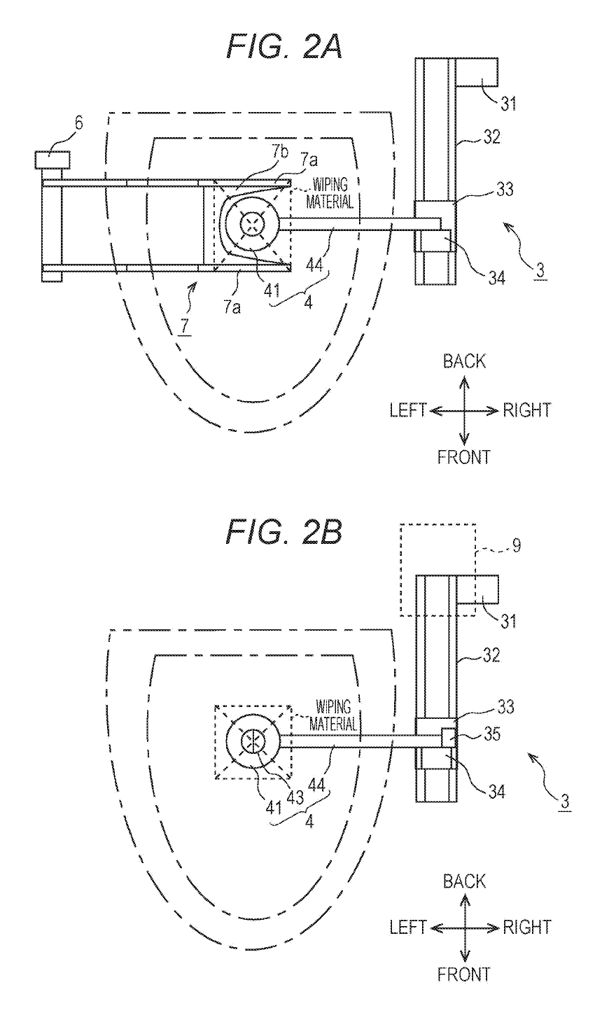

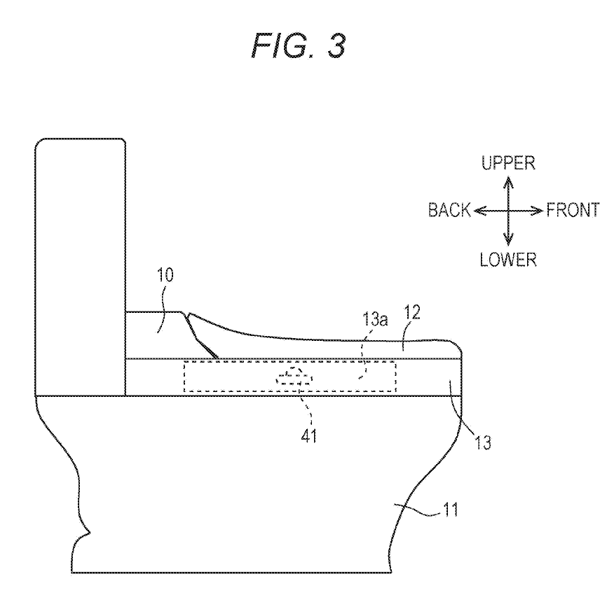

FIG. 1A is a block diagram of a functional configuration of a buttock wiping device 1 using a paper placement guide 7. FIG. 2A is a plan view of an outline mechanism of the buttock wiping device 1 illustrated in FIG. 1A. FIG. 3 is a side view of a relationship among a toilet bowl 11, a toilet seat 12, a warm-water cleansing device 10, and a raised portion 13. The paper placement guide 7 has a structure proposed in JP-A-2017-006616 and JP-A-2017-006617. Specifically, the paper placement guide 7 has an extendable mechanism, and includes, e.g., two extendable rails 7a and a plate 7b on which a wiping material is to be placed. The paper placement guide 7 is, by a paper placement guide drive unit 6, extendable from the left to the right of the toilet seat. For example, a lower portion of the paper placement guide 7 has a rack structure, and the paper placement guide drive unit 6 includes a pinion and a motor. The pinion is rotated by the motor to move a rack, and in this manner, the paper placement guide 7 can extend/contract right to left. The wiping material placed on the paper placement guide 7 moves from below the toilet seat, and then, is exposed substantially below the anus. Then, as illustrated in FIG. 2A, a head portion 41 of a wiping arm 4 moves upward from below the wiping material, thereby lifting the wiping material. Wiping is performed with the wiping material contacting the buttocks. As illustrated in FIG. 3, the head portion 41 of the wiping arm 4 can be exposed on a toilet bowl side through a clearance 13a provided at the raised portion 13.

Note that the raised portion 13 is not necessarily provided. The thickness of the toilet seat 12 may be increased such that the clearance 13a is provided at the toilet seat 12, and in this manner, the wiping arm 4 may be exposed on the toilet bowl side through the clearance 13a. Alternatively, the toilet seat 12 or the warm-water cleansing device 10 may be slightly raised such that the wiping arm 4 is exposed through a clearance formed between the toilet bowl 11 and the toilet seat 12 by such raising.

That is, the present disclosure is not limited to the case of using the raised portion. Thus, the present disclosure is also usable for, e.g., a structure in which a toilet seat lifting/lowering device is used to form a clearance between the toilet bowl and the toilet seat such that the wiping arm is exposed on the toilet bowl side through such a clearance. Moreover, the present disclosure is also usable for, e.g., a structure in which a hole is formed at the toilet bowl such that the wiping arm is exposed on the toilet bowl side through such a hole.

In FIG. 1A, the buttock wiping device 1 includes, in addition to the paper placement guide 7 and the paper placement guide drive unit 6, a control unit 2, a wiping arm drive unit 3, the wiping arm 4, and an operation unit 5. The wiping arm 4 includes the head portion 41, a three sensor 42, and an arm portion 44. The head portion 41 fitting the shape of the vicinity of the anus is attached to a tip end of the arm portion 44. The control unit 2 is configured to control operation of the paper placement guide drive unit 6 and operation of the wiping arm drive unit 3 according to operation of the operation unit 5 by a user. The control unit 2 is configured to adjust control of the wiping arm drive unit 3 according to force detected by the force sensor 42. The wiping arm drive unit 3 includes a plurality of motors, and is configured to move the wiping arm 4 back and forth, up and down, or right to left.

Various mechanisms configured to move the wiping arm 4 are conceivable. For example, as illustrated in FIG. 2A, the wiping arm drive unit 3 includes a front-to-back drive motor 31, rails 32, a right-to-left rotation motor 33 placed on a table slidably provided on the rails, and an upper-to-lower motor 34 attached to the right-to-left rotation motor 33. By rotation of the front-to-back drive motor 31, the table slides on the rails 32, and therefore, the wiping arm 4 can move back and forth. A base portion of the wiping arm 4 is attached to the upper-to-lower motor 34. At an original position in a retracted state, the wiping arm 4 is disposed parallel to the rails 32. In wiping, the front-to-back drive motor 31 rotates to move the wiping arm 4 forward. Subsequently, the right-to-left rotation motor 33 rotates to expose the wiping arm on the toilet bowl side as illustrated in FIG. 2A. Subsequently, the upper-to-lower motor 34 rotates such that the wiping arm 4 inclines diagonally upward, and then, the head portion 41 moves upward to contact the buttocks through the wiping material. In this manner, wiping is executed. Upon completion of wiping, the upper-to-lower motor 34 inclines the wiping arm 4 diagonally downward, and then, the head portion 41 moves downward to drop the wiping material. Subsequently, each motor of the wiping arm drive unit 3 is driven to return the wiping arm 4 to the original retracted position. Note that after wiping, the paper placement guide drive unit 6 reversely returns the paper placement guide 7, and retracts the paper placement guide 7 to an original position.

An outline structure of the buttock wiping device 1 using the paper placement guide 7 has been described above. Next, an outline structure of a buttock wiping device 1 having the structure of holding a wiping material by a head portion 41 will be described.

FIG. 1B is a block diagram of a functional configuration of the buttock wiping device 1 when an openable portion 43 is used for the head portion 41. FIG. 2B is a plan view of an outline mechanism of the buttock wiping device 1 illustrated in FIG. 1B. Note that FIG. 3 is also used for the buttock wiping device 1 of FIGS. 1B and 2B.

In FIG. 1B, the buttock wiping device 1 includes a control unit 2, a wiping arm drive unit 3, a wiping arm 4, an operation unit 5, an automatic paper feeding control unit 8, and a paper feeding unit 9. The wiping arm 4 includes the head portion 41, a force sensor 42, the openable portion 43, and an arm portion 44. The head portion 41 includes the openable portion 43 configured to open/close according to control of the wiping arm drive unit 3. The shape of the openable portion 43 fits the shape of the vicinity of the anus. The control unit 2 is configured to control operation of the wiping arm drive unit 3 according to operation of the operation unit 5 by a user. Moreover, the control unit 2 is configured to adjust control of the wiping arm drive unit 3 according to force detected by the force sensor 42.

The wiping arm drive unit 3 includes a plurality of motors, and is configured to move the wiping arm 4 back and forth, up and down, or right to left. As illustrated in FIG. 2B, an outline mechanism of the wiping arm drive unit 3 is similar to that of the wiping arm drive unit 3 illustrated in FIG. 2A, but is different in a single point that the wiping arm drive unit 3 has a wire traction motor 35.

The openable portion 43 is, through a wire, coupled to the wire traction motor 35. The wire traction motor 35 has a mechanism to pull or loose the wire to open/close the openable portion 43. The openable portion 43 is closed with the wiping material being placed on the openable portion 43, and therefore, the wiping material is attached to the head portion 41.

The paper feeding unit 9 is a device configured to automatically supply the wiping material onto the head portion 41. For example, the paper feeding unit 9 is a device configured so that toilet paper in a roll shape is fed out, folded, and cut to a predetermined length. Note that in the case of using a thick wiping material, the paper feeding unit 9 may cut, without folding, the wiping material to the predetermined length, and may supply the wiping material onto the head portion 41. The paper feeding unit 9 is controlled by the automatic paper feeding control unit 8. The automatic paper feeding control unit 8 is controlled by the control unit 2. When an instruction for wiping operation is provided by the operation unit 5, the control unit 2 instructs the automatic paper feeding control unit 8 to feed paper. Accordingly, the automatic paper feeding control unit 8 controls operation of the paper feeding unit 9 to form the wiping material cut in a folded state, and then, places such a wiping material on the head portion 41. By inserting a not-shown paper attachment portion into a clearance formed in opening/closing of the openable portion 43 of the head portion 41, the wiping material is inserted into the head portion 41. Subsequently, the openable portion 43 is closed such that the wiping material is attached to the head portion 41. Note that the paper feeding unit 9 is not limited to above, and a device configured to place, one by one, the pre-cut wiping material on the head portion 41 may be used.

After attachment of the wiping material, wiping is executed in such a manner that the wiping arm 4 is moved from a retracted position to an exposed position as illustrated in FIG. 2B. After completion of wiping, the wire traction motor 35 looses the pulled openable portion 43. A spring is attached to the openable portion 43 in a direction in which the openable portion 43 constantly opens. Thus, when the pulled wire is loosed, the wiping material is easily detached from the openable portion 43. The upper-to-lower motor 34 inclines the wiping arm 4 downward, and therefore, the wiping material drops. Subsequently, the wiping arm drive unit 3 returns the wiping arm 4 to an original retracted position. Note that various structures of the openable portion 43 are conceivable, and are not intended to limit the present disclosure.

The outline mechanism of the buttock wiping device 1 in the case where the wiping material is held by the head portion 41 has been described above.

The present disclosure may be applicable not only to the buttock wiping device 1 using the paper placement guide 7, but also to the buttock wiping device 1 configured such that the wiping material is held by the head portion 41. In any case, the wiping arm 4 includes the force sensor 42. The force sensor 42 is configured to detect force when the head portion 41 is pressed against the buttocks, thereby transmitting a signal on the detected force to the control unit 2. The control unit 2 receives the signal from the force sensor 42, and determines whether or not the force applied in wiping exceeds a predetermined force or falls within a predetermined force range, for example. Then, the control unit 2 controls operation of the wiping arm drive unit 3 such that the head portion 41 contacts the buttocks with proper force.

In a control method by the control unit 2, in a case where the control unit 2 determines, based on the signal from the force sensor 42, that the force exceeds the predetermined force (wiping force is too strong), the control unit 2 controls the wiping arm drive unit 3 to lower the force sensor 42, for example. Conversely, in a case where the control unit 2 determines, based on the signal from the force sensor 42, that the force is equal to or smaller than the predetermined force (the wiping force is too weak), the control unit 2 controls the wiping arm drive unit 3 to lift the force sensor 42. With this structure, in the case where the force exceeds the predetermined force, contact force of the head portion 41 can be weakened, and therefore, the head portion 41 can contact within the predetermined force range. The control method is not limited to these methods, and the control unit 2 controls, according to the force detected by the force sensor 42, the wiping arm drive unit 3 to adjust the level of force of wiping by the wiping arm 4.

For example, a strain gauge, a load cell, or a semiconductor pressure sensor can be used as the force sensor 42, but the present disclosure is not limited to these sensors. As long as the force of pressing the head portion 41 can be detected, any force sensors may be used. Note that for preventing narrow interpretation of the scope of the present disclosure by use of the term “sensor,” units configured to detect force are collectively referred to as a “force detection unit” in the present disclosure.

Next, attachment of the force sensor 42 to the wiping arm 4 will be specifically described with reference to multiple embodiments.

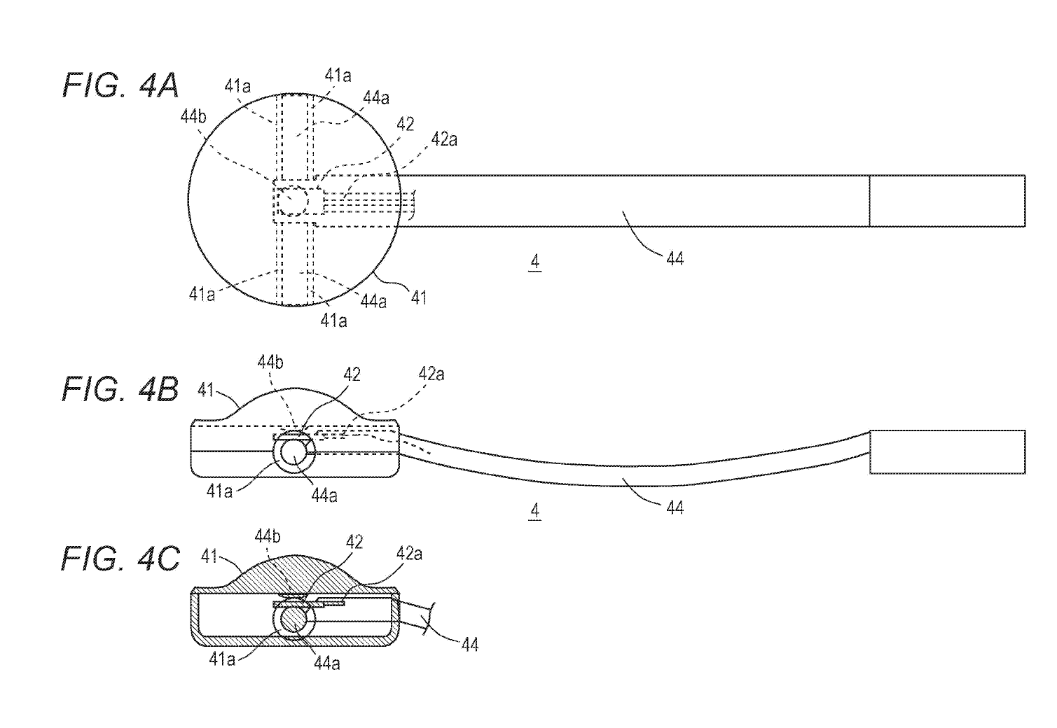

FIG. 4A is a plan view of a wiping arm 4 of a first embodiment. FIG. 4B is a front view of the wiping arm 4 of FIG. 4A. FIG. 4C is a sectional view of the inside of a head portion 41 of FIG. 4B. An arm portion 44 of the wiping arm 4 is formed of, e.g., an easily-bendable metal plate or resin plate. A rotary shaft 44a is attached to a tip end of the arm portion 44, thereby forming a T-shape. The rotary shaft 44a is inserted into a hole 41a provided at the head portion 41. With this structure, when the arm portion 44 inclines upward, the head portion 41 is, by rotation, held horizontal, and therefore, properly contacts the vicinity of the anus.

A force sensor 42 is attached to the tip end of the arm portion 44. A line 42a from the force sensor 42 passes through the inside of the arm portion 44, and then, is electrically connected to a control unit 2. Note that an electric system of the force sensor 42 may be, as necessary, subjected to waterproofing. By waterproofing, the head portion 41 can be cleansed.

A protrusion 44b is provided inside the head portion 41, and is provided at a position which is to contact the force sensor 42. A slight clearance is provided between the hole 41a and the rotary shaft 44a. Thus, when the head portion 41 contacts the buttocks, force applied from the protrusion 44b to the force sensor 42 increases/decreases according to the intensity of contact force. A greater contact force results in a higher pressure applied from the protrusion 44b to the force sensor 42. Thus, the control unit 2 can recognize firm contact of the head portion 41. On the other hand, a smaller contact force results in a lower pressure applied from the protrusion 44b to the force sensor 42. Thus, the control unit 2 can recognize gentle contact of the head portion 41.

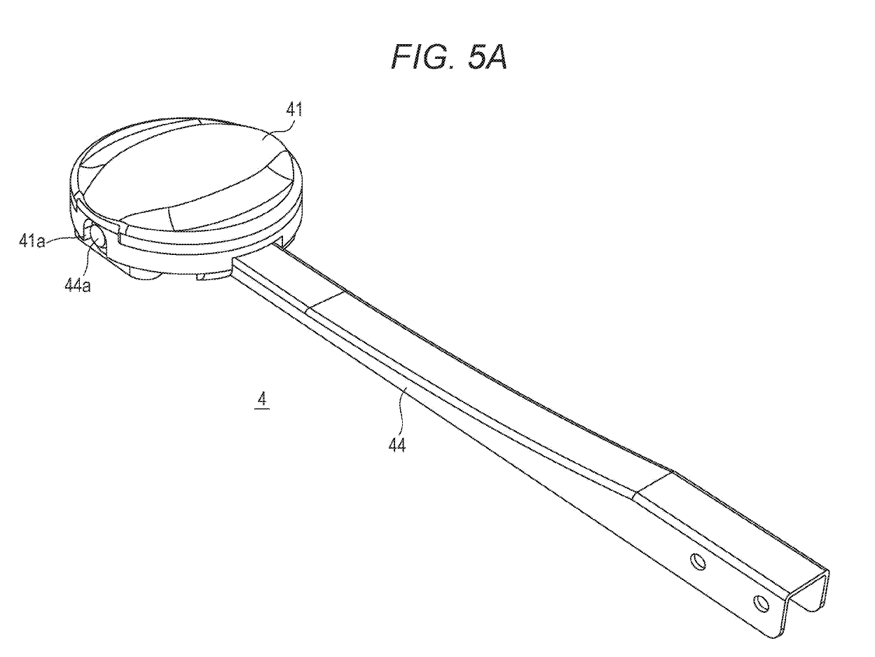

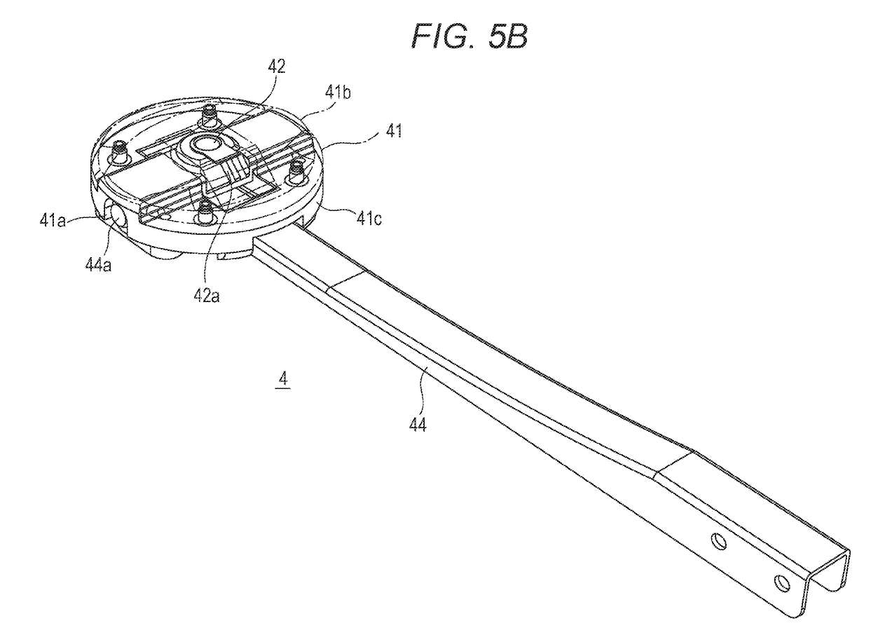

FIG. 5A is a perspective view of a wiping arm 4 of a second embodiment. FIG. 5B is a perspective view of the wiping arm 4 with a head portion 41 of FIG. 5A being transparent for the sake of clarifying the inside of the head portion 41. A rotary shaft 44a is attached to a tip end of an arm portion 44, and is rotatably inserted into a hole 41a. As illustrated in FIG. 5B, a force sensor 42 is attached to a lower portion of the head portion 41. In FIGS. 4A to 4C, the entirety of the head portion 41 is attached to the rotary shaft 44a with a slight clearance. Unlike such a structure, the head portion 41 is, in FIGS. 5A and 5B, attached with such looseness that an upper portion 41b (a transparent portion in FIG. 5B) of the head portion 41 has a slight clearance from a lower portion 41c (a non-transparent portion in FIG. 5B) of the head portion 41. Moreover, the force sensor 42 is provided between the upper portion 41b and the lower portion 41c of the head portion 41. With this structure, when the head portion 41 contacts the buttocks, the upper portion 41b comes into contact with the force sensor 42 so that contact force can be detected. Then, according to a signal detected by the force sensor 42, a control unit 2 controls operation of a wiping arm drive unit 3 to control the contact force of the head portion 41 on the buttocks.

As described above, as illustrated in FIGS. 4A to 4C and FIGS. 5A and 5B, the force sensor is attached such that the head portion 41 applies the force to the force sensor 42, and therefore, the force when the head portion 41 is pressed against the buttocks can be detected.

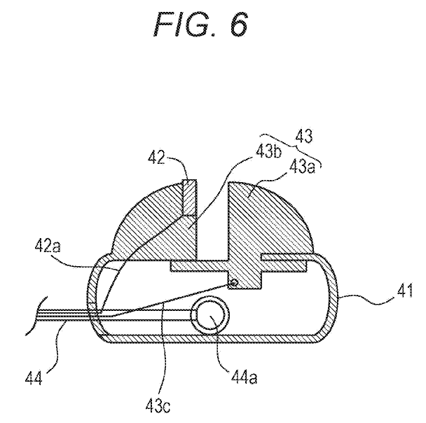

FIG. 6 is a sectional view of a head portion 41 of a wiping arm 4 of a third embodiment. An embodiment of the head portion 41 having an openable portion 43 will be described with reference to FIG. 6. In FIG. 6, openable portions 43a, 43b are provided at an upper portion of the head portion 41. The openable portion 43a on the right side as viewed in the figure has such a structure that the openable portion 43a is slidable right to left as viewed in the figure by a wire 43c penetrating an arm portion 44. By a not-shown spring, force in an opening direction is constantly applied to the openable portion 43a. When the wire 43c is pulled, the openable portion 43a is pulled toward the openable portion 43b on the left side. With this structure, a wiping material placed on the head portion 41 can be held by the openable portion 43. When the pulled wire 43c is loosened, the openable portion 43a is moved to the right side as viewed in the figure by the spring, and therefore, the held wiping material is released. In this embodiment, a force sensor 42 is attached to the non-slidable openable portion 43b of the openable portion 43. For example, a load cell may be used as the force sensor, and may be embedded in the openable portion 43b. Thus, force upon contact of the head portion 41 can be detected. As described above, attachment of the force sensor 42 to the openable portion 43 also allows detection of the force when the head portion 41 is pressed against the buttocks.

Note that in addition to opening/closing of the openable portion by pulling of the wire, e.g., a mechanism for opening/closing the openable portion by pushing/pulling of a rod or rotation of a rod may be provided. For pushing/pulling the rod, an electromagnetic solenoid or a direct drive type motor may be used. In this case, a mechanism such as a gear for rotating the head by pushing/pulling of the rod may be provided in the head portion 41. For rotating the rod, a motor may be used. In this case, a mechanism such as a gear for converting rotation movement of the rod into opening/closing movement of the openable portion may be provided in the head portion 41.

Note that in FIG. 6, the openable portion 43 is used. However, in the case of a structure not using the openable portion 43, a force sensor such as a load cell may be attached to the head portion 41 in such a manner that the force sensor is embedded in an upper surface of the head portion 41. Thus, the force when the head portion 41 is pressed against the buttocks may be detected.

(Variations)

A location where the force detection unit is placed is not limited to the inside of the head portion 41. The force detection unit may be provided at the arm portion 44 or in the vicinity of the arm portion 44. Variations in such a case will be described below.

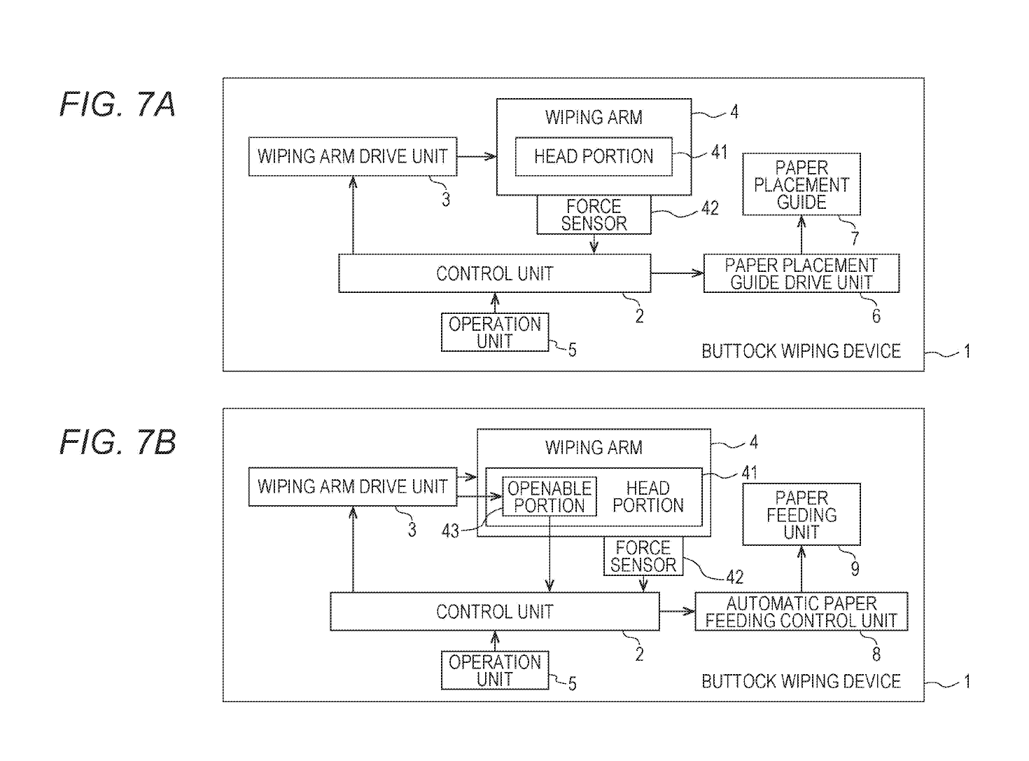

FIGS. 7A and 7B are block diagrams of a functional configuration in the case where the force sensor 42 is attached to the arm portion 44 or the vicinity thereof. The vicinity of the arm portion 44 as described herein means that the force sensor 42 is disposed not to contact the arm portion 44, but is disposed with such closeness that the force can be detected by deformation, such as bending, due to force application to the arm portion 44. FIGS. 7A and 7B are similar to FIGS. 1A and 1B, except that the force sensor 42 is illustrated outside the head portion 41. As illustrated in FIGS. 7A and 7B, the force sensor 42 may be provided outside the head portion 41, and an installation location thereof is not specifically limited. For example, the force sensor 42 may be attached to the arm portion 44, or may be attached with a slight distance from the arm portion 44. Specific examples will be described below.

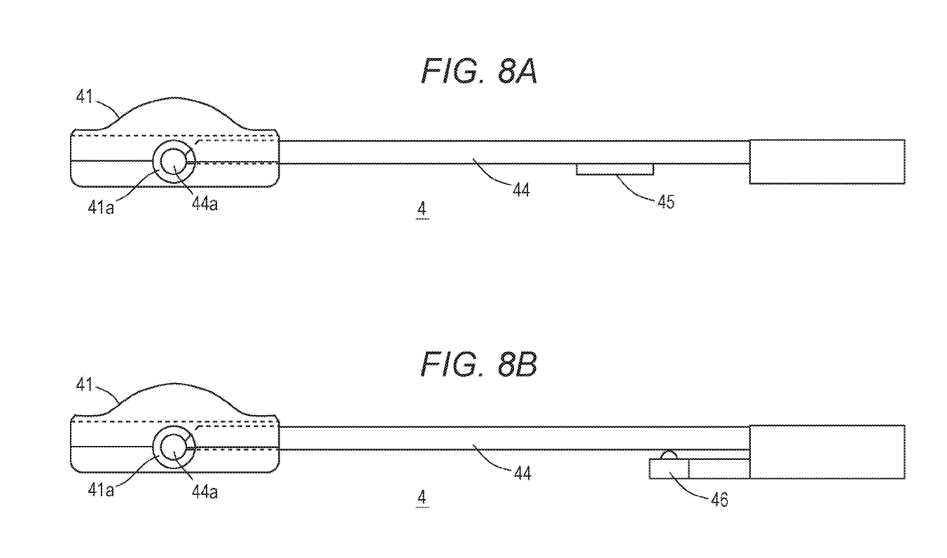

FIG. 8A is a side view when a strain gauge 45 as the force sensor 42 is attached to the arm portion 44. The same reference numerals as those of FIG. 4B are used to represent similar functions in FIG. 8A, and description thereof will not be repeated. In FIG. 8A, the strain gauge 45 is attached to the arm portion 44. Thus, when the head portion 41 contacts the buttocks, the arm portion 44 strains according to contact pressure. The strain gauge 45 can detect such strain, thereby detecting the force when the wiping arm 4 contacts the buttocks. The strain gauge 45 is attached to the arm portion 44 as described above, and therefore, electric wiring is not necessary for the head portion 41. Consequently, a maintenance process such as cleansing of the head portion 41 is facilitated.

FIG. 8B is a side view when a load cell 46 as the force sensor 42 is attached to the arm portion 44. The same reference numerals as those of FIG. 4B are used to represent similar functions in FIG. 8B, and description thereof will not be repeated. In FIG. 8B, the load cell 46 is attached to the vicinity of the arm portion 44. In this example, the load cell 46 is fixed to a base portion of the arm portion 44. When the arm portion 44 bends, the arm portion 44 pushes the load cell 46 so that the load cell 46 can detect such pushing force. Thus, the force applied to the arm portion 44 can be detected. Since the load cell 46 is attached to the base of the arm portion 44 as described above, the electric wiring is not necessary for the head portion 41. Consequently, the maintenance process such as cleansing of the head portion 41 is facilitated.

Thus, as illustrated in FIGS. 8A and 8B, the force detection unit may be provided at the arm portion 44 or in the vicinity thereof.

Note that the structure for attaching the wiping material to the wiping arm is not limited to the structure using the openable portion 43. For example, the head portion 41 does not necessarily open/close, and an wiping arm having a holding portion for holding the wiping material may be used for the arm portion 44. Moreover, such a wiping arm may include the force detection unit at the head portion 41, or may include the force detection unit at the arm portion 44 or in the vicinity thereof. An example of the structure in the case of providing the holding portion at the arm portion 44 will be described below.

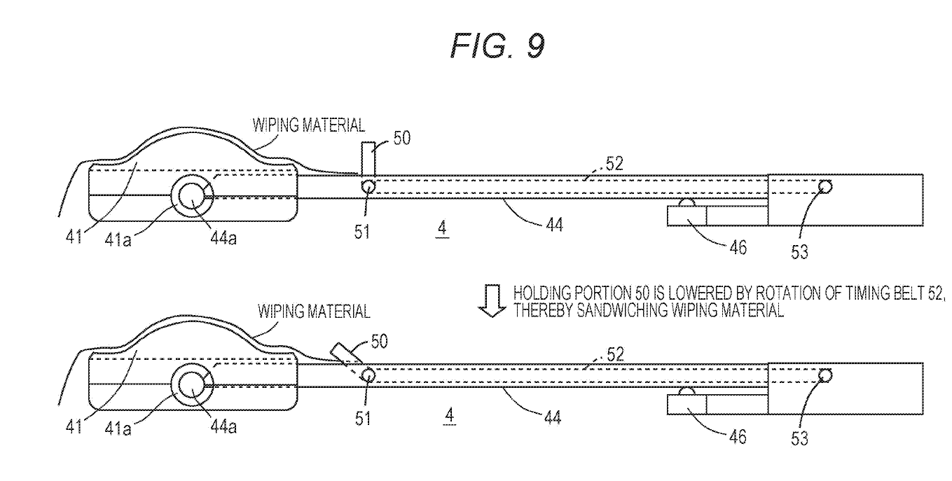

FIG. 9 is a side view of the wiping arm 4 in the case of providing a holding portion 50 at the arm portion 44. As illustrated in an upper view of FIG. 9, the holding portion 50 rotatable about a shaft 51 is attached to the arm portion 44. Moreover, a pulley, a gear, etc. are attached to the shaft 51 and a base-side shaft 53, and a timing belt 52 is winded around the pulley, the gear, etc. A not-shown motor etc. rotate the shaft 53 so that the holding portion 50 can swing up and down. As illustrated in a lower view of FIG. 9, the holding portion 50 is lowered by rotation of the timing belt 52 so that the wiping material can be held by the holding portion 50. In paper discharging, the timing belt 52 rotates to lift the holding portion 50, and the wiping arm 4 is inclined downward or inverted by the base-side motor. In this manner, the wiping material is discharged. For the wiping arm 4 as illustrated in FIG. 9, the force detection unit is also provided at the head portion 41 or the arm portion 44 or in the vicinity of the arm portion 44, and therefore, the force while the wiping arm 4 is wiping the buttocks can be detected.

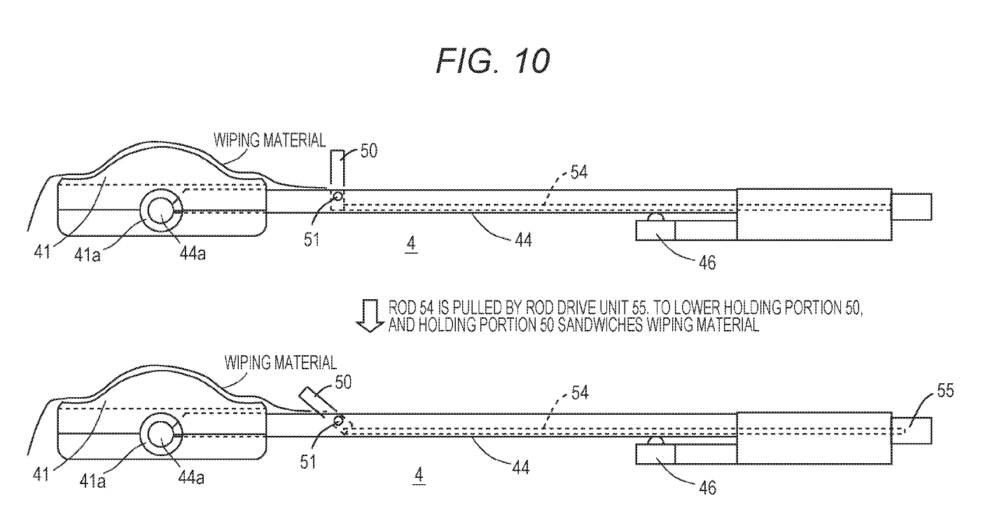

FIG. 10 is another side view of the wiping arm 4 in the case of providing the holding portion 50 at the arm portion 44. As illustrated in an upper view of FIG. 10, the holding portion 50 rotatable about the shaft 51 is attached to the arm portion 44. Moreover, a lower portion of the holding portion 50 is pushed/pulled by a rod 54 so that the holding portion 50 can swing up and down. A rod drive unit 55, such as an electromagnetic solenoid or a direct drive type motor, at the base portion is used for pushing/pulling of the rod 54. By pulling the rod 54, the holding portion 50 can be lowered. By pushing the rod 54, the holding portion 50 can be lifted. Paper discharging is similar to that in the case of FIG. 9. As described above, for the wiping arm 4 as illustrated in FIG. 10, the force detection unit is also provided at the head portion 41 or the arm portion 44 or in the vicinity of the arm portion 44, and therefore, the force while the wiping arm 4 is wiping the buttocks can be detected.

Note that in FIGS. 9 and 10, the case of using the load cell 46 is illustrated. Needless to say, the force sensor 42 may be disposed as illustrated in FIG. 4B, or the strain gauge 45 may be disposed as illustrated in FIG. 8A.

As described above, in the embodiments of the present disclosure, the wiping arm includes the force sensor so that the contact force of the head portion 41 on the buttocks can be controlled. Thus, the buttock wiping device configured to adjust the pressure on the buttocks in wiping can be provided.

The present disclosure has been described above in detail. However, such description has been merely an example of the present disclosure in every respect, and is not intended to limit the scope of the present disclosure. Needless to say, various modifications and changes can be made without departing from the scope of the present disclosure. The constituent features of the present disclosure in the present specification are regarded as independent features. Embodiments made by combination of the constituent features in any combination methods are included in the present disclosure.

The present disclosure relates to a buttock wiping device, and is industrially applicable.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A buttock wiping arm whose operation is controlled by a buttock wiping device for wiping buttocks with a wiping material, comprising:
an arm portion;
a head portion configured to press the wiping material against the buttocks; and
a force detection unit configured to detect force when the wiping material is pressed against the buttocks.

2. The buttock wiping arm according to claim 1, wherein
the force detection unit is a strain gauge, a load cell, or a semiconductor pressure sensor.

3. The buttock wiping arm according to claim 1, wherein
the force detection unit is attached such that the head portion applies the force to the force detection unit when the wiping material is pressed against the buttocks.

4. The buttock wiping arm according to claim 1, wherein
the head portion includes an openable portion configured to hold the wiping material, and
the force detection unit is attached to the openable portion of the head portion.

5. The buttock wiping arm according to claim 1, wherein
the force detection unit is attached to the head portion.

6. The buttock wiping arm according to claim 1, wherein
the force detection unit is attached to the arm portion or a vicinity of the arm portion.

7. The buttock wiping arm according to claim 1, wherein
the force detection unit is a strain gauge attached to the arm portion, and
the strain gauge is configured to detect strain when the arm portion strains, thereby detecting the force.

8. The buttock wiping arm according to claim 1, wherein
the force detection unit is a load cell attached to a base portion of the arm portion, and
the load cell is configured to detect force of pushing the load cell when the arm portion bends, thereby detecting the force.

9. A buttock wiping device comprising:
the buttock wiping arm according to any one of claim 1.
